(19) United States
(12) Patent Application Publication
(10) Pub. No.: US 2007/0279782 A1
(43) Pub. Date: Dec. 6, 2007

(54) METHOD AND APPARATUS FOR DETERMINING OFFSET BETWEEN READ AND WRITE TRANSDUCERS IN A DISK DRIVE

(76) Inventor: Abdul R. Rydhan, San Jose, CA (US)

Correspondence Address: SCHWEGMAN, LUNDBERG & WOESSNER, P.A., P.O. BOX 2938, MINNEAPOLIS, MN, 55402, US

(21) Appl. No.: 11/421,435

(22) Filed: May 31, 2006

(51) Int. Cl. G11B 27/36

(52) U.S. Cl. 360/31

(57) ABSTRACT

A method of measuring an offset between a read head and a write head at a position on a disk in a disk drive includes writing a test track at a first frequency, and writing a track adjacent to the test track at a second frequency. The method also includes moving an actuator of the disk drive to a position the read head over the test track, reading information associated with the test track while moving the read head across the test track, and substantially filtering information associated with the adjacent track. The method also includes monitoring a parameter of the disk drive to determine the center of a test track.

### BACKGROUND

A disk drive is an information storage device. A disk drive includes one or more disks clamped to a rotating spindle, and at least one transducing head for reading information representing data from and/or writing data to the surfaces of each disk. More specifically, storing data includes writing information representing data to portions of tracks on a disk. Data retrieval includes reading the information representing data from the portion of the track on which the information representing data was stored. Disk drives also include an actuator that positions the transducing head(s) over selected data tracks on the disk(s) for either reading information from the disk or writing information to the disk. Most actuators in disk drives pivot about an axis. These actuators are called rotary actuators and move the transducing head, which is attached or integrally formed with the actuator, through a arc so that the transducing head to sweeps across a surface of the rotating disk. The rotary actuator is driven by a voice coil motor.

Current transducing heads include a separate read element and a separate write element that are formed on the transducing head. The read element and the write element are physically separated by a distance to prevent the magnetic field produced by passing write current through the write head from damaging the read element. In many current disk drives, the read element is a magneto resistive (MR) element which is capable of reading very small magnetic fields stored on the disk. In other words, the read elements are very sensitive to magnetic fields and can be damaged if subjected to a magnetic field used to write information to the disk. Therefore, the read element is magnetically shielded from the write element. The magnetic shield separates the read and write elements. There may also be additional spacing between the read and write elements that is designed into a transducing head.

The physical distance between the write element and the read element on the transducing head results in what is known as microjog. In a rotary actuator, microjog refers to the difference in position over a track between the write element and the read element at a specific rotary position of the transducing head. In other words, in some of the positions of a rotary actuator with respect to a selected track in a disk drive, the write head may not be over the selected track when the read head is positioned over the selected track. The distance that the write head is offset from the position over the selected or desired track can be termed as the microjog. In many disk drives, the read head and separate write head are aligned with the center of the actuator. To minimize microjog over the stroke or entire sweep of the rotary actuator, generally the read head and the write head align about midway through the stroke. In other words, when the read head and the write head align, the actuator will not need to be moved when switching between reading and writing. At other positions in the stroke, the actuator must be moved when switching between reading and writing. Currently, the tracks are so closely positioned, at some points in the stroke of the actuator arm, the read head can be positioned over the track while the write head is positioned over a track that is 20 tracks away from the read head.

It is necessary to measure the amount of microjog along the stroke of the rotary actuator so the rotary actuator can be moved to compensate for the amount of microjog. In other words, for a given position of the rotary actuator, the rotary actuator must be repositioned to place the write head over the same track where the read head was used to read servo or position information.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is an exploded view of a disk drive that uses example embodiments described herein.

FIG. 2 is a schematic diagram of a transducing head positioned over a disk in a disk drive, according to an example embodiment.

FIG. 3 is a schematic diagram showing portions of the read/write path or channel of the disk drive, according to an example embodiment.

FIG. 4 is a method for measuring the microjog or offset distance between a read transducer and a write transducer, according to an example embodiment.

FIG. 5 is a method for measuring the microjog, or offset distance between a read transducer and a write transducer, at various locations across the disk, according to another example embodiment.

FIG. 6 is shows a test track surrounded by adjacent tracks written at a different frequency than the test track, according to an example embodiment.

FIG. 7 is a graph showing the output of the automatic gain control (AGC) associated with the read/write path or channel, according to an example embodiment.

FIG. 8 is a representation of a computing system, according to an example embodiment.

FIG. 9 is a schematic of a machine-readable medium having an instruction set, according to an example embodiment.

The description set out herein illustrates the various embodiments of the invention and such description is not intended to be construed as limiting in any manner.

### DETAILED DESCRIPTION

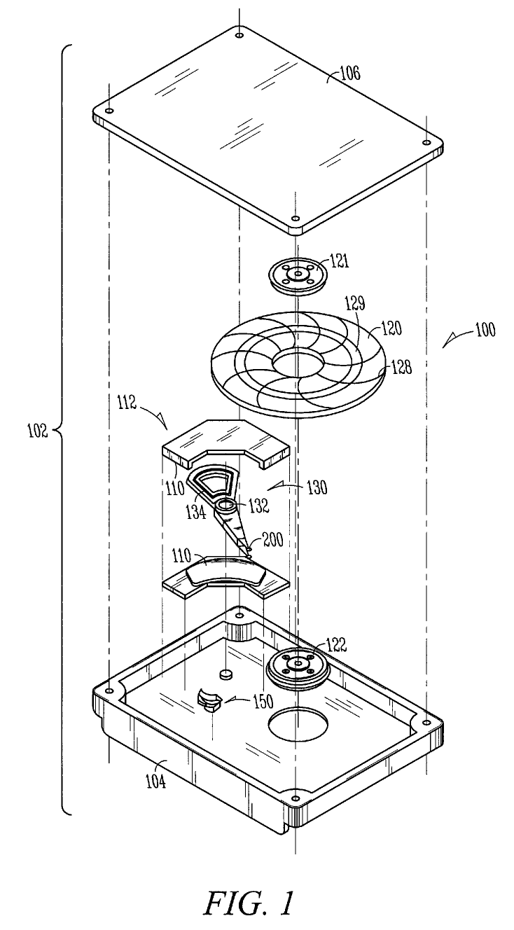

FIG. 1 is an exploded view of disk drive 100 that uses various embodiments of the present invention. The disk drive 100 includes a housing 102 including a housing base 104 and a housing cover 106. The housing base 104 illustrated is a base casting, but in other embodiments a housing base 104 can comprise separate components assembled prior to, or during assembly of the disk drive 100. A disk 120 is attached to a hub or spindle 122 that is rotated by a spindle motor. The disk 120 can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. The disk 120 can be made of a light aluminum alloy, ceramic/glass or other suitable substrate, with magnetizable material deposited on one or both sides of the disk. The magnetic layer includes small domains of magnetization for storing data transferred through a transducing head 200. The transducing head 200 includes a separate read element and a separate write element. For example, the separate read element can be a magneto-resistive head, also known as a MR head. The write element can be a thin film head that is used for writing information to the disk 120. It will be understood that different types of write heads and read heads can be used in a transducing head 200.

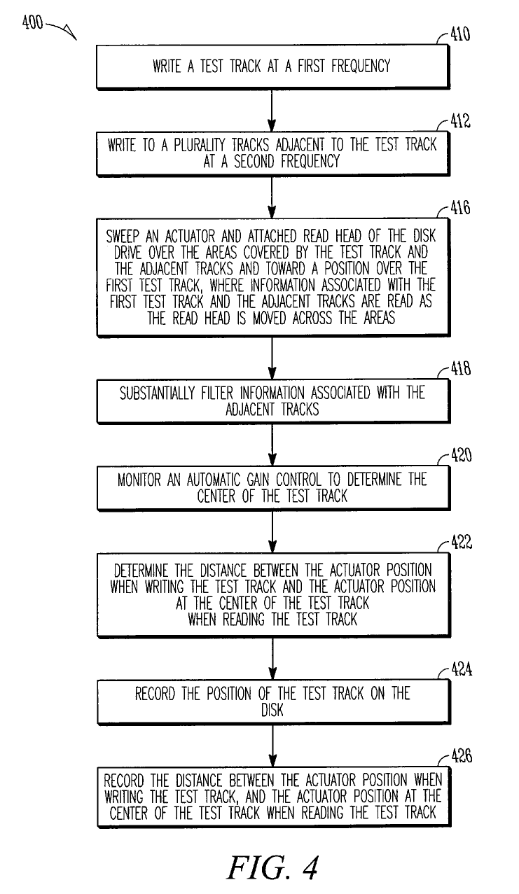

A rotary actuator 130 is pivotally mounted to the housing base 104 by a bearing 132 and sweeps an arc between an inner diameter (ID) of the disk 120 and a ramp 150 positioned near an outer diameter (OD) of the disk 120. Attached to the housing 104 are upper and lower magnet return plates 110 and at least one magnet that together form the stationary portion of a voice coil motor (VCM) 112. A voice coil 134 is mounted to the rotary actuator 130 and positioned in an air gap of the VCM 112. The rotary actuator 130 pivots about the bearing 132 when current is passed through the voice coil 134 and pivots in an opposite direction when the current is reversed, allowing for control of the position of the actuator 130 and the attached transducing head 200 with respect to the disk 120. The VCM 112 is coupled with a servo system (shown in FIG. 4) that uses positioning data read by the transducing head 200 from the disk 120 to determine the position of the head 200 over one of a plurality of tracks on the disk 120. The servo system determines an appropriate current to drive through the voice coil 134, and drives the current through the voice coil 134 using a current driver and associated circuitry (not shown in FIG. 1).

Each side of a disk 120 can have an associated transducing head 200, and the transducing heads 200 are collectively coupled to the rotary actuator 130 such that the transducing heads 200 move in unison. The invention described herein is equally applicable to devices wherein the individual heads separately move some small distance relative to the actuator. This technology is referred to as dual-stage actuation (DSA).

A servo system provides position information to the transducing head 200. One servo system is an embedded, servo system in which tracks on each disk surface used to store information representing data contain small segments of servo information. The servo information, in some embodiments, is stored in radial servo sectors or servo wedges 128 shown as several narrow, somewhat curved spokes substantially equally spaced around the circumference of the disk 120. It should be noted that in actuality there may be many more servo wedges than as shown in FIG. 1.

The disk 120 also includes a plurality of tracks on each disk surface. The plurality of tracks is depicted by two tracks, such as track 129 on the surface of the disk 120. The servo wedges 128 traverse the plurality of tracks, such as track 129, on the disk 120. The plurality of tracks, in some embodiments, may be arranged as a set of substantially concentric circles. Data is stored in fixed sectors along a track between the embedded servo wedges 128. The tracks on the disk 120 each include a plurality of data sectors. More specifically, a data sector is a portion of a track having a fixed block length and a fixed data storage capacity (e.g. 512 bytes of user data per data sector). The tracks toward the inside of the disk 120 are not as long as the tracks toward the periphery of the disk 110. As a result, the tracks toward the inside of the disk 120 can not hold as many data sectors as the tracks toward the periphery of the disk 120. Tracks that are capable of holding the same number of data sectors are grouped into a data zones. Since the density and data rates vary from data zone to data zone, the servo wedges 128 may interrupt and split up at least some of the data sectors. The servo wedges 128 are typically recorded with a servo writing apparatus at the factory (called a servo-writer), but may be written (or partially written) with the disk drive's 100 transducing head 200 in a self-servowriting operation.

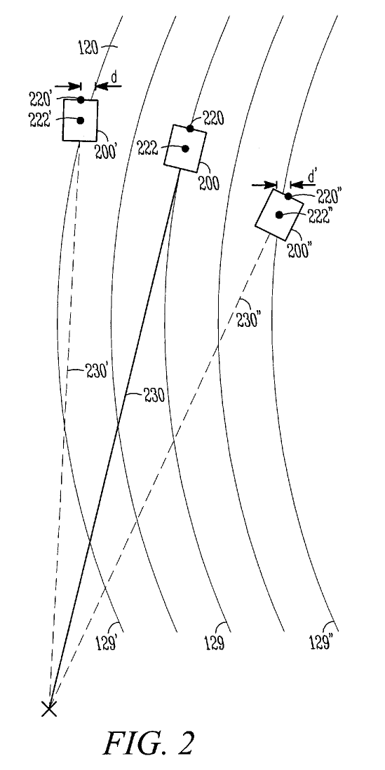

Execution of a write command for storing data includes writing information representing data to a specific selected track that can be found again when the information needs to be retrieved. A read element in a transducing head 200 reads the servo information to provide position information, such as a track number and a sector number within the track. Once a selected position is found using the read head and servo information, the write head can be positioned over the track and sector and data can be written to it. As shown below, in some actuator positions, the write head may not be over the selected track when the read head is positioned over the selected track. The distance that the write head is offset from the position over the selected or desired track can be termed as the microjog. The actuator has to be moved to reposition the write head over the track before writing begins so that information representing data is not overwritten and lost. In other words, in some of the positions of a rotary actuator with respect to a selected track in a disk drive, the write head may not be over the selected track when the read head is positioned over the selected track. The distance that the write head is offset from the position over the selected or desired track can be termed as the microjog. This is explained in more detail with the aid of FIG. 2.

FIG. 2 is a schematic diagram of a transducing head 200 positioned over a disk 120 in a disk drive 100, according to an example embodiment. FIG. 2 actually shows a schematic diagram of a transducing head 200 attached to an actuator 230 which is rotated about a pivot point 232 to various positions over the disk 120. As shown in FIG. 2, the actuator 230 and the attached transducing head 200 is positioned in three different example positions. The transducing head 200 also includes a write head 220 and a read head 222. The write head 220 is spaced away from the read head 222 for several purposes. One purpose includes the need to shield the read head 222 from the magnetic field produced by the write head 220 when a write current is passed through the write head 220. It should also be noted that the physical separation between the read head 222 and the write head 220 is exaggerated in FIG. 2 for the sake of illustration. In the first position, the read head 200 is located over track 129 on the disk 220. In this particular position, the read head 222 and the write head are substantially aligned with the track 229. As a result, there is a no microjog or offset distance through which the actuator 230 must rotate or move in order to switch between the read head 222 and the write head 220. In other words, in the position shown over track 129, the read head 222 and the write head 220 are aligned and are both centered over the track 129. This, of course, is not the case with other positions of the actuator 230. For example, when the actuator 230′ is over the track 129′, the read head 222′ is positioned over the track 129 while the write head 220′ is not positioned over the track 129. Therefore, in order to switch from the read head 222′ to the write head 220′, the actuator must be repositioned through a distance designated D, and which is also known as the microjog. When the actuator 230″ and the transducer head 200″ is positioned over the track 129″, the read head 222″ is positioned over the track 129″ while the write head 220″ is not positioned over the track 129″. The actuator must be moved through a distance D′ to compensate for the offset of the read head 222″ with respect to the write head 220″ when positioned over the track 129″. It should be noted that the distances D and D′, which are the offset distances corresponding to the microjog, shown in FIG. 2 are exaggerated for the sake of illustration.

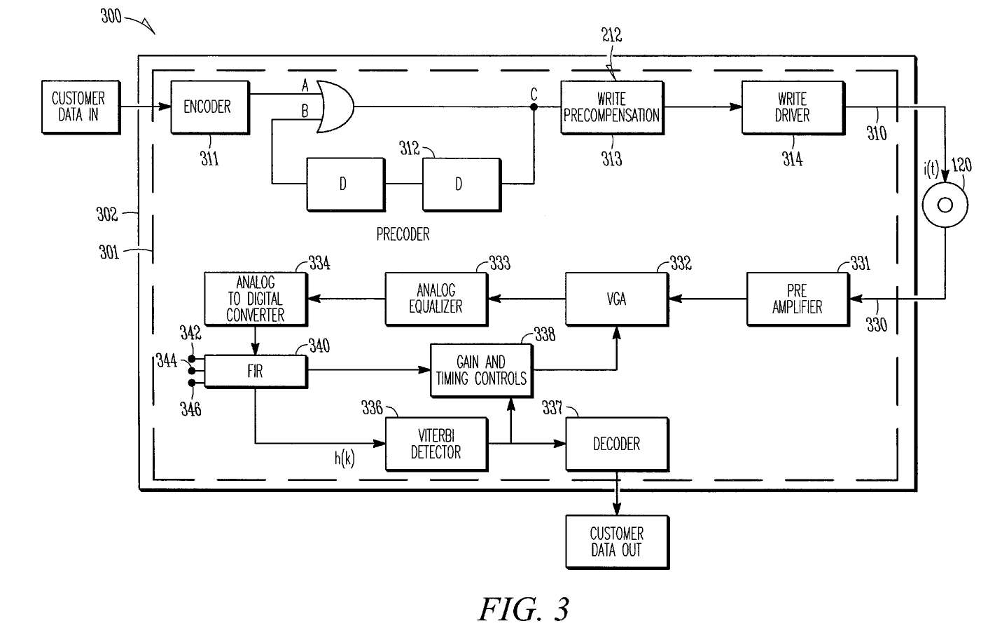

FIG. 3 is a schematic diagram of a read/write path 300 of the disk drive 100, according to an example embodiment. The read/write path 300 includes a write channel portion 310 and a read channel portion 330. The read/write path 300 is typically housed on a semiconductor chip, as depicted by the dotted line 301. The semiconductor chip is also placed on a printed circuit board 302, which is in turn attached to the housing 104 of the disk drive 100 (see FIG. 1). This is shown schematically in FIG. 3 so the size of the chip or semiconductor chip 301 relative to the printed circuit board 302 is out of scale. The read/write path 300 is typically contained in a semiconductor chip called a encoder/decoder (ENDEC). The read/write path 300 includes the write portion 310, which includes an encoder 311 and a precoder 312 for encoding the customer data, a write precompensation module 313, and a write driver 314. The write precompensation module 313 adjusts the signals associated with the encoded data so that, as written on the disk 120, the data will be more easily read using the read channel portion 330. The write driver 314 determines where the data will be written.

The read channel portion 330 of the read/write path includes a preamplifier 331, a variable gain amplifier 332, an analog equalizer 333, and an analog to digital converter 334. The elements 331 to 334 are used to amplify an analog signal, equalize it and convert it to a digital signal. After being converted by the analog to digital converter 334, the signal is then filtered by a finite impulse response (FIR) filter 340. A signal form the FIR 340 is then fed into a viterbi detector 336, and finally decoded by a decoder 337. A signal from the FIR 340 is also input to the gain and timing controls 338. A signal from the viterbi detector 336 is also fed to gain and timing controls 338. The gain and timing controls 338 are part of a feedback control loop to the variable gain amplifier 332. The FIR filter 340 includes various taps 342, 344, 346 that can be used to shape the signal or used to attenuate or substantially attenuate unwanted portions of a signal or attenuate an unwanted signal. It should be noted that FIG. 3 is one representative example of a read/write path 300.

FIG. 4 is a method 400 for measuring the microjog or offset distance between a read transducer (e.g., read head) and a write transducer (e.g., write head), according to an example embodiment. The method 400 of measuring an offset between a read head and a write head at a position on a disk in a disk drive includes writing a test track (e.g., a first test track) at a first frequency as shown in block 410, and writing to a plurality of tracks adjacent to the first test track at a second frequency, as shown at block 412. The plurality of tracks written to include tracks on both sides of the test track. Generally, a number of adjacent tracks will be written to on each side of the test track. Writing a track adjacent to the first test track at a second frequency includes selecting a frequency that can be substantially attenuated in a read/write channel of the disk drive. The method 400 also includes sweeping an actuator and attached read head of the disk drive over the areas covered by the test track and the adjacent tracks and toward a position over the first test track, where information associated with the first test track and the adjacent tracks are read as the read head is moved across the areas (see block 416), and substantially filtering information associated with the adjacent tracks as shown in block 418. In one embodiment, substantially filtering information associated with the adjacent track includes using a read channel of the disk drive to substantially attenuate the information associated with the adjacent track. In another embodiment, substantially filtering information associated with the adjacent track includes using a finite impulse response having a tap value set to substantially attenuate the information associated with the adjacent track. The method 400 also includes monitoring an automatic gain control to determine the center of the test track as shown in block 420. Once the center of the test track is found, the distance between the actuator position when writing the test track and the actuator position at the center of the test track when reading the test track is determined as shown in block 422. The method 400 includes recording the position of the test track on the disk (see block 424), and recording the distance between the actuator position when writing the test track, and the actuator position at the center of the test track when reading the test track (see block 426). The adjacent track are written at a second frequency so that when the first track is read at a later time, the first track written at the first frequency can be isolated from the adjacent tracks. This prevents an error where a track other than the first track (the selected test track) is mistakenly read from in determining the microjog.

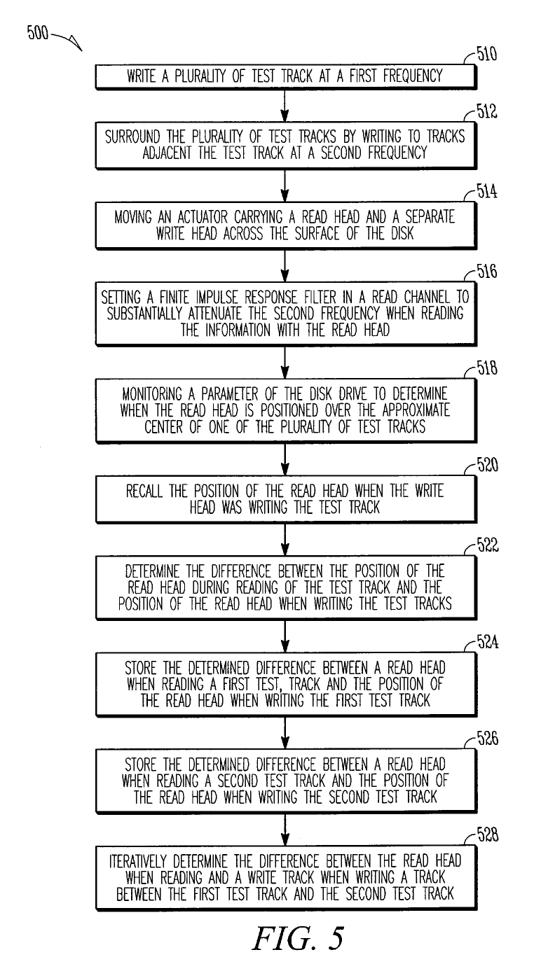

FIG. 5 is a method 500 for measuring the microjog, or offset distance between a read transducer and a write transducer, at various locations across the disk, according to another example embodiment. The method 500 of measuring an offset between a read head and a write head at various positions on a disk in a disk drive includes writing a plurality of test tracks at a first frequency as shown at block 510, and surrounding the plurality of test tracks by writing to tracks adjacent the test track at a second frequency as shown at block 512. The method 500 further includes moving an actuator carrying a read head and a separate write head across the surface of the disk (see block 514), and setting a finite impulse response filter in a read channel to substantially attenuate the second frequency when reading the information with the read head (see block 516). The method 500 also includes monitoring a parameter of the disk drive to determine when the read head is positioned over the approximate center of one of the plurality of test tracks as shown in block 518. In one example embodiment, an automatic gain control signal associated with the read signal is monitored to determine when the read head is positioned over the approximate center of one of the plurality of test tracks. The approximate center of one of the plurality of test tracks corresponds to a minimum in the automatic gain control (AGC) signal. When the read head is sweeping over the adjacent tracks written at the second frequency, the read channel is attenuating the signal. In other words, the read channel attenuates the signal which means there is little or substantially no signal. In the presence of little or no signal, the AGC tries to boost the “small” signal so the AGC is high when reading the second frequency signal associated with the tracks adjacent the test track or test tracks. In some embodiments, finding the center of the written test track can also include monitoring the error rate associated with the read signal of the written test track. In still another example, the AGC is monitored to find the center and the error rate is monitored to confirm the center of the track. In still other example embodiments, the AGC is monitored to find the approximate center and the error rate is used to fine tune the center found using the AGC. The center of the track will correspond to a minimum error rate. The method 500 also includes recalling the position of the read head when the write head was writing the test track (see block 520), and determining the difference between the position of the read head during reading of the test track and the position of the read head when writing the test tracks (see block 522). In one embodiment, the determined difference between a read head when reading a first track, and the position of the read head when writing the test track is stored for a first test track (see block 524) and a second test track (see block 526). The method 500 further includes an iterative determination of the difference between the read head, when reading, and a write head when writing a track between the first test track and the second test track 528.

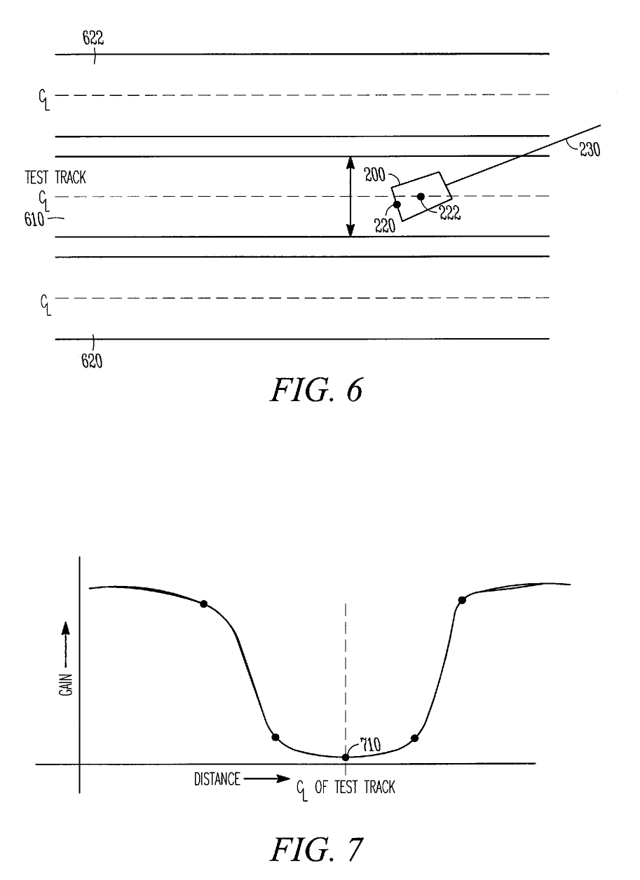

FIG. 6 shows a test track 610 written at a first frequency. FIG. 6 also includes a first adjacent track 620 written at a second frequency which abuts or is adjacent the first test track 610 as well as a second test track 622, which is adjacent or abuts the test track 610. Track 620 and 622 are written at a second frequency. In some embodiments, a plurality of tracks adjacent tracks are written about the first test track 610. The frequency selected for the adjacent tracks 620 and 622 is a frequency that can be attenuated by a portion of the read channel of the disk drive. Therefore, when the actuator 230 passes the transducing head 200 and specifically the read head 222 over the adjacent tracks, such as adjacent track 622 and adjacent track 620, the read signal will be attenuated by a component in the read channel. In one embodiment, this is a finite impulse response (FIR) filter. The tap weights associated with the filter can be selected to selectively attenuate certain frequencies. In the alternative, certain tap weights are typically used in order to shape wave forms produced from a read signal by the read head 222. The frequency selected for the adjacent tracks 620 and 622 can be selected so that those tap weights already selected will attenuate the frequency of the signals in track 620 and 622.

FIG. 7 is a graph showing the output of the automatic gain control associated with the read/write path or channel versus the distance through which the transducing head 200 swings. The minimum of the gain depicted by point 710 corresponds to the center line of the test track 610. In other words, when the read head 222 is positioned over the certain line of the test track 610, the amount of automatic gain that has to be used to boost the signal is minimalized. Therefore, by looking at the AGC output or the gain needed, one can approximate or discern the center line of the test track 610.

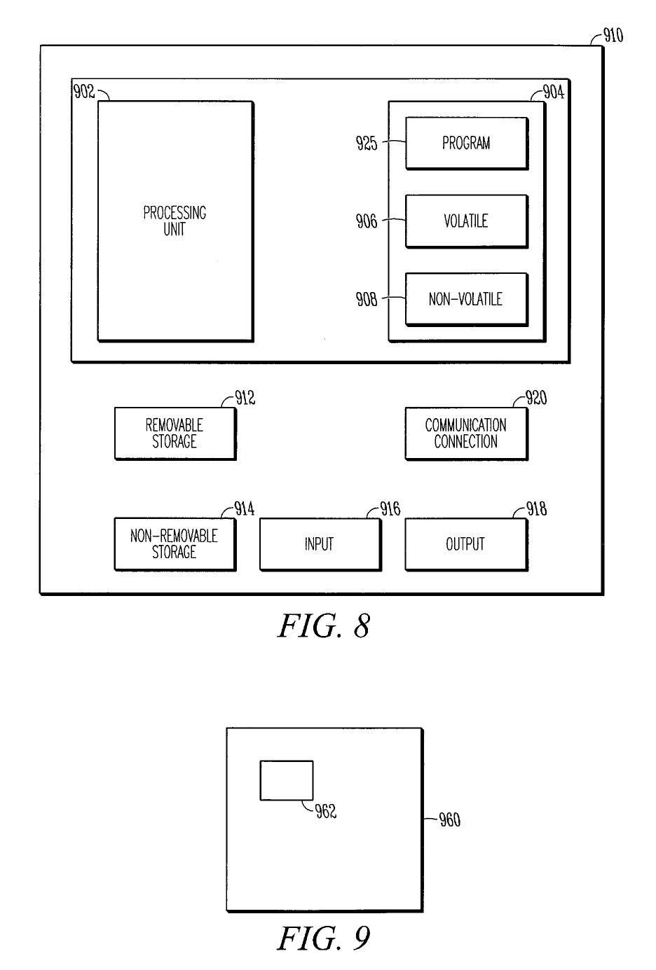

A block diagram of a computer system that executes programming for performing the above algorithm is shown in FIG. 8. A general computing device in the form of a computer 910, may include a processing unit 902, memory 904, removable storage 912, and non-removable storage 914. Memory 904 may include volatile memory 906 and non volatile memory 908. Computer 910 may include any type of information handling system in any type of computing environment that includes any type of computer-readable media, such as volatile memory 906 and non volatile memory 908, removable storage 912 and non-removable storage 914. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 910 may include or have access to a computing environment that includes input 916, output 918, and a communication connection 920. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. A microprocessor or controller associated with the disk drive 100 (see FIG. 1) is also such a computer system.

Computer-readable instructions stored on a machine-readable medium are executable by the processing unit 902 of the computer 910. A hard drive, CD-ROM, and RAM are some examples of articles including a machine-readable medium. For example, a computer program 925 executed to control the writing of information associated with successive flush cache commands from a host 440 according to the teachings of the present invention may be included on a CD-ROM and loaded from the CD-ROM to a hard drive. The computer program may also be termed firmware associated with the disk drive 100. In some embodiments, a copy of the computer program 925 can also be stored on the disk 120 of the disk drive 100.

FIG. 9 is a schematic diagram that shows a machine readable medium 960 and an instruction set 962 associated with the machine readable medium 960, according to an example embodiment. The machine-readable medium 960 provides instructions 962 that, when executed by a machine, such as a computer, cause the machine to perform operations for measuring an offset between a read head and a write head at a position on a disk in a disk drive. The operations include writing a test track with a write head at a first frequency, recording the position of the read head when the write head is writing the test track, writing to a first track adjacent to the test track at a second frequency, and writing to a second track adjacent to the test track at a second frequency. The operations also include reading information associated with the test track while moving the read head across the disk, and substantially filtering information associated with the tracks written at a second frequency. The operations performed also include monitoring an automatic gain control of the disk drive to determine the center of the test track.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method of measuring an offset between a read head and a write head at a position on a disk in a disk drive, the method comprising:
writing a test track at a first frequency; and
writing a track adjacent to the test track at a second frequency.

2. The method of claim 1 wherein writing a track adjacent to the test track at a second frequency includes selecting a frequency that can be substantially attenuated in a read/write channel of the disk drive.

3. The method of claim 1 further comprising moving an actuator of the disk drive to a position the read head over the test track.

4. The method of claim 3 further comprising:
reading information associated with the test track while moving the read head across the test track; and
substantially filtering information associated with the adjacent track.

5. The method of claim 4 wherein substantially filtering information associated with the adjacent track includes using a read channel of the disk drive to substantially attenuate the information associated with the adjacent track.

6. The method of claim 4 wherein substantially filtering information associated with the adjacent track includes using a finite impulse response having a tap value set to substantially attenuate the information associated with the adjacent track.

7. The method of claim 4 further comprising monitoring an automatic gain control to determine the center of the test track.

8. The method of claim 7 further comprising measuring the distance between the actuator position when writing the test track and the actuator position at the center of the test track when reading the test track.

9. The method of claim 8 further comprising:
recording the position of the test track on the disk; and
recording the distance between the actuator position when writing the test track and the actuator position at the center of the test track when reading the test track.

10. The method of claim 1 wherein writing a track adjacent to the test track at a second frequency includes writing a track at a second frequency on each side of the test track.

11. A method of measuring an offset between a read head and a write head at various positions on a disk in a disk drive, the method comprising:
writing a plurality of test tracks at a first frequency; and
surrounding the plurality of test tracks by writing to tracks adjacent the test track at a second frequency.

12. The method of claim 11 further comprising:
moving an actuator carrying a read head and a separate write head across the surface of the disk; and
setting a finite impulse response filter in a read channel to substantially attenuate the second frequency when reading the information with the read head.

13. The method of claim 12 further comprising monitoring an automatic gain control signal associated with the read signal to determine when the read head is positioned over the approximate center of one of the plurality of test tracks.

14. The method of claim 13 wherein the approximate center of one of the plurality of test tracks corresponds to a minimum in the automatic gain control signal.

15. The method of claim 13 further comprising monitoring the error rate associated with the read signal to find the center of the written test track.

16. The method of claim 13 further comprising:
recalling the position of the read head when the write head was writing the test track; and
determining the difference between the position of the read head during reading of the test track and the position of the read head when writing the test tracks.

17. The method of claim 16 wherein the determined difference between a read head when reading a first track and the position of the read head when writing the test track is stored for a first test track and a second test track, the method further comprising iteratively determining the difference between the read head when reading and a write track when writing a track between the first test track and the second test track.

18. A machine-readable medium that provides instructions that, when executed by a machine, cause the machine to perform operations for measuring an offset between a read head and a write head at a position on a disk in a disk drive comprising:
writing a test track with a write head at a first frequency;
recording the position of the read head when the write head is writing the test track;
writing to a first track adjacent to the test track at a second frequency; and
writing to a second track adjacent to the test track at a second frequency

19. The machine-readable medium of claim 18 that provides instructions that, when executed by a machine, further cause the machine to perform operations that further comprise:
reading information associated with the test track while moving the read head across the disk; and
substantially filtering information associated with the tracks written at a second frequency.

20. The machine-readable medium of claim 18 that provides instructions that, when executed by a machine, further cause the machine to perform operations that further comprise monitoring an automatic gain control of the disk drive to determine the center of the test track.

21. The machine-readable medium of claim 18 that provides instructions that, when executed by a machine, further cause the machine to perform operations that further comprise sending a signal indicating the completion of a write cache command after writing the information associated with the flush cache command to one of the plurality of flush cache memory locations.
